(19) United States
(12) Patent Application Publication
(10) Pub. No.: US 2026/0126775 A1
(43) Pub. Date: May 7, 2026

(54) COMPUTER-IMPLEMENTED METHOD, COMPUTER PROGRAM, DATA CARRIER SIGNAL, AND MANUFACTURING SYSTEM FOR GENERATING CONTROL DATA FOR CONTROLLING AT LEAST ONE MANUFACTURING MACHINE

(71) Applicant: Carl Zeiss Digital Innovation GmbH, Dresden (DE)

(72) Inventors: Franz-Georg Ulmer, Vogtareuth (DE); Daniel Goersch, Dresden (DE)

(21) Appl. No.: 19/437,143

(22) Filed: Dec. 30, 2025

Related U.S. Application Data
(63) Continuation of application No. PCT/EP2023/067962, filed on Jun. 30, 2023.

(51) Int. Cl. G05B 19/4097; G05B 19/401

(52) U.S. Cl. CPC G05B 19/4097; G05B 19/401

(57) ABSTRACT

The disclosure relates to a computer-implemented method, to a computer program, to a data carrier signal and to a manufacturing system for generating control data for controlling at least one manufacturing machine, wherein a plurality of steps for manufacturing process control are included for this purpose and point cloud data relating to a workpiece are registered, wherein the registration of the point cloud data relating to the workpiece is based on a singular value decomposition (SVD) of a difference matrix of the point cloud data with determination of the associated singular vectors and/or on a determination of the eigenvectors of a covariance matrix of the point cloud data that is formed from the difference matrix, wherein the difference matrix is formed from the difference between the point cloud data coordinates and the center of gravity coordinates of the point cloud.

### CROSS REFERENCE TO RELATED APPLICATIONS

This application is a continuation application of international patent application PCT/EP2023/067962, filed Jun. 30, 2023, designating the United States, and the entire content of the application is incorporated herein by reference.

### TECHNICAL FIELD

The disclosure relates to a computer-implemented method, a computer program, a data carrier signal, and a manufacturing system for generating control data for controlling at least one manufacturing machine. The present computer-implemented method is not only a disclosure following the classical definition, that includes a computer, a computer network, or any other programmable device in which all or part of at least one feature is realized with a computer program, but also, in the age of cloud computing, a disclosure that additionally and/or alternatively includes a method for generating control data for controlling at least one manufacturing machine that takes place on at least one processor and/or takes place under the control of at least one processor and/or is initiated by at least one processor, the method including steps that are performed on the at least one and/or another processor.

### BACKGROUND

In many branches of industry, efforts are being made to integrate the measurement technology necessary for quality assurance in production into the production line or even into the actual manufacturing machines. For example, U.S. Pat. No. 6,969,821 B2 discloses a method or a manufacturing machine for producing turbine blades in which the measurement technology for quality assurance is already integrated in the manufacturing machine.

In addition, U.S. Pat. No. 10,220,566 B2, U.S. Pat. No. 10,532,513 B2, U.S. Pat. No. 11,104,064 B2, and US 2021/0379823 A1 describe measurement technology for an additive manufacturing (AM) process that is accordingly integrated in the manufacturing machine.

There are several reasons for this approach. First, the measurement technology, which today is largely designed for measuring room infrastructure (controlled temperature, cleanroom/gray room, low vibration, etc.), is expensive. Second, the measuring rooms are separate from production and thus complicate workpiece logistics. In addition, the remote measuring rooms produce long latencies, and so the measurement results obtained there at a later time cannot be used for effectively controlling production. Furthermore, the information from the measuring rooms is not conditioned in such a way that production can use it in automated form for process control.

Therefore, remote measuring rooms are unsuitable for online capture and online control of process states, especially in sometimes global manufacturing alliances, and also cannot support process development or process approaches for the increasing demand for small-series and one-off production.

Furthermore, the measuring rooms take up large areas that can otherwise be used for production. In addition, highly qualified personnel must be provided for the measuring rooms. The degree of automation when using measuring rooms is also low and thus gives rise to additional personnel costs.

Accordingly, U.S. Pat. No. 10,180,667 B2 describes a measurement technology integrated in the manufacturing machine where the measurement results are interpreted by a trained artificial intelligence (AI). WO 2018/204410 also describes a trained AI in which measurement results from metrology sensors or from coordinate measuring machines are processed via a cloud computing network or management system for one or more manufacturing machines.

For all measurement technologies integrated in the production line, the fundamental problem is comparing the point cloud recorded from a workpiece with target specifications, usually inspection plans derived from computer-aided design (CAD) data. To achieve this, the recorded point clouds of the workpiece must first be transferred, for the actual comparison, to the computer coordinate system or CAD coordinate system by way of a registration, i.e., an alignment based on the CAD model, with a rotation and a translation. This applies in particular if the workpieces are guided past the measurement technology sensors for measuring the point clouds in an uncoordinated manner at any location and with any orientation on a conveyor belt, or if the workpieces are held in the capture range of the measurement technology sensors for measuring the point clouds, for example by robots in different poses.

In this regard, U.S. Pat. No. 11,049,236 B2 describes a special solution that is particularly suitable for registering flat workpieces moving on a conveyor belt.

### SUMMARY

It is an object of the present disclosure, in view of the prior art, to provide a robust method suitable for all types of workpieces, which can be used globally on all possible manufacturing machines, and which permits a quick target/actual comparison, based on inspection plans or CAD models, with point clouds recorded from the workpiece in order to generate new control commands for controlling a manufacturing machine.

The object is achieved according to an aspect of the disclosure by a computer-implemented method, and/or a method carried out on at least one processor and/or carried out under the control of at least one processor and/or is initiated by at least one processor, for generating control data for controlling at least one manufacturing machine, the method including the following steps and at least one of the following steps of the method being performed on the at least one and/or another processor:
obtaining point cloud data of a workpiece;
registering the point cloud data of the workpiece;
fitting geometric surface elements and/or form elements to the point cloud data of the workpiece;
obtaining an inspection plan and/or a CAD model of the workpiece and, where applicable, actual control data and/or, where applicable, available infrastructure or environmental data of at least one manufacturing machine for manufacturing the workpiece;
comparing the inspection plan and/or CAD model of the workpiece with the fitted surface elements and/or form elements and identifying divergences;
evaluating or assessing the divergences identified in the comparison, where applicable based on specified tolerances of the workpiece and, where applicable, the actual control data and/or, where applicable, the infrastructure or environmental data;
generating new target control data and/or new infrastructure or environmental data of the manufacturing machine for continued manufacture of the workpiece or for manufacturing a new workpiece in accordance with the evaluation; and
transferring the new target control data and/or, where applicable, the new infrastructure or environmental data to the at least one manufacturing machine and/or to at least one other manufacturing machine and/or to a factory controller superordinate to the at least one manufacturing machine and/or the at least one other manufacturing machine in accordance with the evaluation;
   the registration of the point cloud data of the workpiece being based on a singular value decomposition (SVD) of a difference matrix of the point cloud data with determination of the associated singular vectors and/or on a determination of the eigenvectors of a covariance matrix of the point cloud data that is formed from the difference matrix, the difference matrix being formed from the difference between the point cloud data coordinates and the centroid coordinates of the point cloud.

According to an aspect of the present disclosure, the object is further achieved by a computer program which includes commands that, when the program is executed by at least one processor, causes the at least one processor and/or other processors to carry out the method described herein.

According to another aspect of the present disclosure, the object is further achieved by a data carrier signal that transmits all or a part of the computer program according to the exemplary embodiments described herein.

According to another aspect of the present disclosure, the object is further achieved by a manufacturing system which includes a computer program according to one of the exemplary embodiments described herein, and at least one processor.

Furthermore, according to another aspect of the present disclosure, the object is achieved by a manufacturing system including at least one processor and at least one memory, the at least one processor interchanging data with the at least one memory, and the manufacturing system being configured to:
obtain point cloud data of a workpiece;
register the point cloud data of the workpiece;
fit geometric surface elements and/or form elements to the point cloud data of the workpiece;
obtain an inspection plan and/or a CAD model of the workpiece and, where applicable, actual control data and/or, where applicable, available infrastructure or environmental data of at least one manufacturing machine for manufacturing the workpiece;
compare the inspection plan and/or CAD model of the workpiece with the fitted surface elements and/or form elements and identifying divergences;
evaluate or assessing the divergences identified in the comparison, where applicable based on specified tolerances of the workpiece and, where applicable, the actual control data and/or, where applicable, the infrastructure or environmental data;
generate new target control data and/or new infrastructure or environmental data of the manufacturing machine for continued manufacture of the workpiece or for manufacturing a new workpiece in accordance with the evaluation; and
transfer the new target control data and/or, where applicable, the new infrastructure or environmental data to the at least one manufacturing machine and/or to at least one other manufacturing machine and/or to a factory controller superordinate to the at least one manufacturing machine and/or the at least one other manufacturing machine in accordance with the evaluation;
   the registration of the point cloud data of the workpiece being based on a singular value decomposition (SVD) of a difference matrix of the point cloud data with determination of the associated singular vectors and/or on a determination of the eigenvectors of a covariance matrix of the point cloud data that is formed from the difference matrix, the difference matrix being formed from the difference between the point cloud data coordinates and the centroid coordinates of the point cloud.

According to an aspect of the disclosure, it has been recognized that the covariance matrix known from statistics or image processing is particularly advantageous for grasping the alignment of point clouds in space from arbitrary, including unknown workpieces, workpieces in unknown positions and attitudes when the point clouds of the workpieces are available only incompletely, for example as a result of concealment or obstructed vision. According to an aspect of the disclosure, the covariance matrix in this instance is formed in relation to a “statistical” expected value in X, Y, and Z with reference to the centroid of the point cloud in X, Y, and Z. The method known from statistics or image processing for forming a covariance matrix and for determining the main axes or the eigenvectors, for example with subsequent singular value decomposition (SVD) of the difference matrix underlying the covariance matrix, is found, according to an aspect of the disclosure, to be superior to other algorithms, robust and reliable for determining the main axes of the alignment of a workpiece in space relative to the measuring machine, even if the information about the workpiece is available only incompletely. Similarly to the cognitive abilities of a human being who, for example, can grasp the alignment of a workpiece in the hands of a colleague in less than one second, even if the workpiece is largely concealed, the covariance matrix or the underlying difference matrix can be used to determine the alignment of the three main axes of a partially concealed workpiece in less than one second with a standard computer used in industry. The alignment determination with the covariance matrix herein is superior to other methods of so-called registration of point clouds or measurement data. The other methods either fundamentally fail due to the incomplete point cloud or require too much time or too much computing capacity due to complex computing operations.

A good overview of the known methods for registering point clouds is provided by Xiaoshui Huang et al.: “A comprehensive survey on point cloud registration”, published at: arXiv:2103.02690v2 [cs.CV] Mar. 5, 2021. An explanation of the singular value decomposition (SVD) of a covariance matrix as a method of multivariant statistics can be found under the keyword “Hauptkomponentenanalyse”, i.e., “Principal Component Analysis PCA” in Wikipedia at: https://de.wikipedia.org/wiki/Hauptkomponentenanalyse or in the tutorial by Lindsay I Smith: “A Tutorial on Principal Components Analysis” at:

https://web.archive.org/web/20210309115736/http://www.cs.otago.ac.nz/cosc453/student_tutorials/principal_components.pdf.

Complete registration of point clouds with regard to a CAD model or with regard to a coordinate system of the CAD or computer model involves two different steps: first, the point cloud must be aligned according to the main axes of the model or the coordinate axes of the computer, for which purpose the point cloud data must be rotated or swiveled into the corresponding coordinate system, and second, the rotated or swiveled point cloud data must be offset from the coordinate origin in such a way that their centroid or a different reference point matches either the coordinate origin or a point on the CAD model. The singular value decomposition (SVD) of the difference matrix or the determination of the singular vectors of the difference matrix and/or the determination of the eigenvectors of the covariance matrix derived from the difference matrix now guarantees the first part of the registration by determining the rotation matrix required for aligning the point cloud data according to the coordinate axes of the computer or the CAD model. On the other hand, most known registration algorithms attempt to perform the two substeps of the registration simultaneously by iteratively minimizing a distance criterion between the point cloud data and the CAD model. This usually requires a complete point cloud for the entire workpiece.

In one exemplary embodiment of the disclosure, another step now involves scalar products of the point cloud data and at least two determined singular vectors and/or eigenvectors being calculated, and/or at least two coordinates in the X and/or Y and/or Z direction of the coordinates of the point cloud data rotated into the computer coordinate system or CAD coordinate system are determined. Both equivalent approaches, calculating scalar products and determining the coordinates of the rotated point cloud data, can in turn be accomplished very quickly and efficiently.

The scalar products formed with the singular vectors or eigenvectors correspond naturally to the scalar products of the point cloud data rotated or swiveled into the model coordinate system and the respective unit vectors of the coordinate axes of the model coordinate system of the CAD model or the computer model and thus the coordinates of the point cloud data in the computer coordinate system or CAD coordinate system. The scalar products formed with the singular vectors or eigenvectors are thus projections of the point cloud data along the singular vectors/eigenvectors or coordinate axes and thus a measure of the expansion of the workpiece. In this respect, a measure of the expansion of the workpiece can be determined very quickly and efficiently based on the scalar products or the coordinates.

In a further exemplary embodiment of the disclosure, the scalar products and/or the coordinates are used to determine the most probable initial value and/or final value of the expansion of the workpiece in the direction of a singular vector and/or an eigenvector and/or in a coordinate direction by considering a density distribution or frequency distribution of the scalar products in the direction of the corresponding singular vector and/or eigenvector and/or by considering a density distribution or frequency distribution of the coordinates.

An accumulation or high density of scalar products or coordinates can be caused only by an edge surface or an end surface of the workpiece since, first, all scalar products of the point cloud data of a surface having the direction of the surface normal or all point cloud data of a surface perpendicular to a coordinate axis have almost the same value of the scalar product or the coordinates, and since, second, the relative number of such surface points measured against the total number of point cloud data is very high. In this respect, it makes sense to consider the density distribution or frequency distribution of the determined scalar products or coordinates in order to reliably and robustly determine the attitude of surfaces of the workpiece in the direction of the singular vectors/eigenvectors or in the coordinate direction.

Those values of the density distribution or frequency distribution of the determined scalar products or coordinates that provide the largest or lowest “absolute value” of the scalar product with respect to the associated singular vector/eigenvector, or the largest or lowest coordinate value, represent, so to speak, the end or start of the workpiece in the direction of the singular vector/eigenvector under consideration, or in the coordinate direction. This determined “absolute value” of the scalar product or coordinate value is then an initial value and/or final value of the expansion of the workpiece in the direction of the associated singular vector/eigenvector, or in the coordinate direction.

In one exemplary embodiment of the disclosure, when considering the density distribution or frequency distribution of the scalar products and/or the coordinates, the evaluation is performed based on mean values, threshold values, half-value widths, threshold value widths and/or gradients of the local density distributions or frequency distributions. Such methods of peak evaluation can be used to safely and reliably determine the most probable initial value and/or final value of the workpiece by determining an averaged “scalar product absolute value” or an averaged “coordinate value” of the peak under consideration. A simple option in this regard is, for example, to determine the most probable initial value and/or final value by calculating the median of the values of the frequency distribution and then determining the points (scalar products or coordinates) for which the frequency distribution exceeds half of the median value for the first time from the positive or negative direction of the eigenvector or coordinate direction under consideration to be the starting point or end point of the workpiece.

In a further exemplary embodiment of the disclosure, the most probable initial value and/or final value of the expansion of the workpiece is determined by identifying the local maximum and/or the local minimum of the first partial derivative of the density distribution or frequency distribution in the direction of the corresponding singular vector and/or eigenvector and/or in the coordinate direction, and, when ambiguities occur, a first extremum in the direction under consideration is used. This method of peak evaluation can be used to safely and reliably determine the most probable initial value and/or final value of the workpiece for example for point cloud data that have been obtained with a computed tomography measurement (voxels).

In one exemplary embodiment, the most probable initial value and/or final value of the expansion of the workpiece in the direction of a singular vector and/or eigenvector and/or in the coordinate direction is determined by evaluating the density distribution or frequency distribution of the scalar products having the largest or smallest absolute value or the coordinates having the largest or smallest absolute value, and scalar products or coordinates that diverge by more than 5%, in particular by more than 1%, from the scalar products or coordinates having the largest or smallest absolute value are ignored for this evaluation. This distance requirement is a simple and effective method for eliminating so-called “outliers” that would otherwise hamper or distort the determination of the initial value and/or the final value.

In a further embodiment of the disclosure, the registration of point cloud data of the workpiece is carried out based on a parallelization by or with the involvement of at least one graphics processor. Such parallelization, for example on the front computer on the manufacturing machine or else in the cloud, for example, can save further computing time.

In one exemplary embodiment of the disclosure, the point cloud data of the workpiece are measured by at least one sensor as coordinates of points on the workpiece and are further-processed by at least one processor to produce point cloud data of the workpiece, the point cloud data representing at least one subregion of the workpiece to be manufactured and the point cloud data being further-processed by this and/or at least one other processor according to the other method steps and/or being transferred to other processors for further processing. This means that the actual situation of the workpiece in the current machining situation is captured with a sensor in or on the manufacturing machine, the measurement data of the sensor being preprocessed by a processor, for example a processor of the front-end computer of the manufacturing machine, a processor of the superordinate factory controller and/or else, for example, by a processor of the cloud, taking into account any calibrations for point cloud data of the workpiece.

In a further exemplary embodiment of the disclosure, the inspection plan and/or the CAD model of the workpiece and, where applicable, the actual control data and/or, where applicable, the available infrastructure or environmental data of the manufacturing machine are preprocessed and transferred by at least one processor of the manufacturing machine and/or by at least one processor of the factory controller superordinate to the manufacturing machine.

This means that the target situation of the workpiece is captured based on inspection plans and/or CAD data and the actual situation of the control data for the manufacturing machine or the actual situation of the machining head and/or the production environment that the manufacturer of the workpiece intends to use to manufacture the workpiece within tolerance when machining with the at least one manufacturing machine, these target data and the envisaged actual situations being preprocessed by a processor, for example a processor of the front-end computer of the manufacturing machine, a processor of the superordinate factory controller and/or also by, for example, a processor of the cloud.

In one exemplary embodiment of the disclosure, the new target control data and/or, where applicable, the new infrastructure or environmental data are further processed by at least one processor of the at least one manufacturing machine and/or the at least one other manufacturing machine and/or by at least one processor of the factory controller superordinate to the at least one manufacturing machine and/or the at least one other manufacturing machine, for manufacturing the new workpiece. This means that the results of the disclosure are fed in the form of new target data into the manufacturing machines and/or factory controller for continued production of the workpiece or for new production of workpieces.

Further features and advantages of the disclosure will be apparent from the description of exemplary embodiments of the disclosure that follows, with reference to the figures, which show details essential to the disclosure. The individual features may be realized in each case individually by themselves or as a plurality in any desired combination in a variant of the disclosure.

It will be understood that the aforementioned features and the features still to be explained below can be used not only in the respectively indicated combination but also singly or in other combinations, without departing from the scope of the present disclosure.

It will also be understood that the features defined in the dependent claims for the computer-implemented method can also be used in the same or an equivalent manner as features for the inventive computer program, for the inventive data carrier signal and as system features for the inventive manufacturing system, without being listed again separately here as corresponding features.

### BRIEF DESCRIPTION OF THE DRAWINGS

The disclosure will now be described with reference to the drawings wherein:

FIG. 1 shows a two-dimensional representation of point cloud measurement data of a transmission shaft of a gearbox for electric bicycles,

FIG. 2 shows an arrangement of the two-dimensional point cloud from FIG. 1 along the determined direction of the main singular vector of the difference matrix or the main eigenvector of the covariance matrix in a horizontal direction as a result of a singular value decomposition (SVD) of the difference matrix formed from the point cloud data shown in FIG. 1,

FIG. 3 shows a density distribution or frequency distribution of the scalar products of point cloud data and singular vectors/eigenvectors in the direction of the main singular vector or main eigenvector of the point cloud data shown in FIG. 1 or in the X direction,

FIG. 4 shows an arrangement of the two-dimensional point cloud shown in FIG. 1 along the zero line in the horizontal direction by taking into account the most probable initial value and/or final value of the expansion of the transmission shaft from FIG. 1 in the direction of the main singular vector or main eigenvector or in the X direction by considering a density distribution or frequency distribution of the scalar products of point cloud data and singular vectors/eigenvectors in the direction of the corresponding main singular vector or main eigenvector or in the X direction,

FIG. 5 shows a flow chart of a method according to an exemplary embodiment of the disclosure,

FIG. 6A shows a schematic representation of a number and arrangement of devices,

FIG. 6B shows a diagram of an example environment in which systems and methods according to an exemplary embodiment may be implemented, and

FIG. 6C shows a diagram of components of a manufacturing system according to an exemplary embodiment of the disclosure.

### DESCRIPTION OF EXEMPLARY EMBODIMENTS

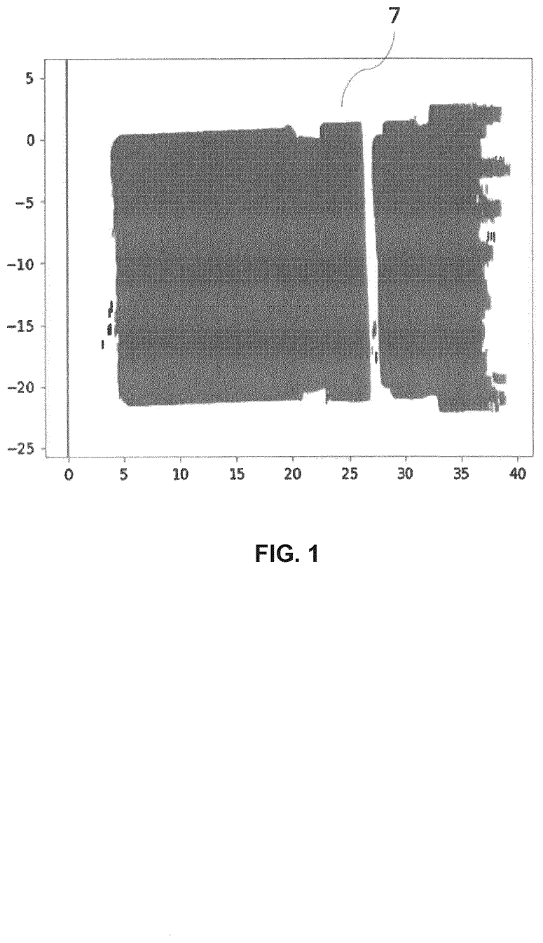

FIG. 1 shows a two-dimensional representation of point cloud measurement data of a transmission shaft 7 of a gearbox for electric bicycles. The two-dimensional representation of the originally three-dimensional point cloud of the measurement data of the transmission shaft 7 as an illustrative workpiece 7 of the disclosure was deliberately chosen to illustrate the registration method, since the rotation and the fitting of a three-dimensional point cloud are difficult to represent in black and white on paper.

The registration method according to an exemplary embodiment of the disclosure is generally based on a three-dimensional point cloud of measurement data, for which three numerical values for the coordinates of each recorded measurement data point in the X, Y, and Z directions relating to the sensor coordinate system are therefore available for each measurement data point of the point cloud. An assumption in this instance is that the sensor head is sufficiently calibrated for recording the measurement data in its sensor coordinate system and that the numerical values for the coordinates correspond to the erroneous absolute values in a metric system within the error tolerance of the sensor head. The measurement data can, for example, be coordinates of points on the surface of the workpiece 7.

However, measurement data resulting from a computed tomography recording of the workpiece with a computed tomography (CT) measuring machine can also be registered with the registration method according to an exemplary embodiment of the disclosure.

Therefore, without limiting the generality, it is assumed hereinafter, to explain the method, that each measurement data point xⁱ has three coordinate values (x, y, z) with respect to the sensor coordinate system and that the associated point cloud of the measurement data is therefore represented by the set of measurement data points {x¹, . . . , xⁿ}.

Furthermore, the point data cloud can be used to form a centroid vector S having the coordinates (Sₓ, S_{y}, S_{z}), where Sₓ is the mean value of all X coordinates of the measurement data points xⁱ and accordingly S_{y} is the mean value of all Y coordinates of the measurement data points xⁱ, and S_{z} is the mean value of all Z coordinates of the measurement data points xⁱ.

Furthermore, a difference matrix M can then be created that, for all measurement points xⁱ collectively, represents the divergence of the measurement points relative to the centroid S, with

$$\text{?} M = \begin{matrix}{( {x}^{1} - S )}^{T} \\ ⋮ \\ {( {x}^{n} - S )}^{T}\end{matrix} ∈ {n \times 3}^{}$$

$$\text{?} \text{indicates text missing or illegible when filed}$$

This difference matrix M can then be used to determine the covariance matrix Σ to give

$$\sum = \frac{1}{n - 1} {M}^{T} M$$

The orientation of the point data cloud can then be calculated by determining the three eigenvectors υ¹, υ², υ³ with the three largest eigenvalues of the covariance matrix Σ, since it can be shown that the largest eigenvalue λ₁ corresponds to an eigenvector υ¹ that represents the direction of the “best-fit” line for the point cloud under consideration. Accordingly, the eigenvectors υ¹ and υ², which belong to the first two largest eigenvalues λ₁ and λ₂, span the “best-fit” level for the point cloud under consideration. It is therefore possible to define a 3×3 rotation matrix Q based on the three eigenvectors υ¹, υ², υ³ with the associated eigenvalues λ₁>λ₂>λ₃ sorted by magnitude, which can be used to align the point cloud data xⁱ available in the sensor coordinate system with regard to the computer coordinate system or CAD coordinate system to give x′ⁱ=Q^{T}xⁱ. The 3×3 rotation matrix Q is given by

$$Q = [ {υ}^{1} , {υ}^{2} , {υ}^{3} ]$$

All eigenvectors υ^{k} of the covariance matrix Σ can be calculated with a normal singular value decomposition (SVD) of M:

$$M = U Z {V}^{T} with U ∈ {n \times n}^{} , Z ∈ {n \times 3}^{} , V ∈ {3 \times 3}^{}$$

The matrix Z of the singular value decomposition has the form:

$$\text{?} Z = \begin{matrix}{σ}_{1} & 0 & 0 \\ 0 & {σ}_{2} & 0 \\ 0 & 0 & {σ}_{3} \\ ⋮ & ⋮ & ⋮ \\ 0 & 0 & 0\end{matrix}$$

$$\text{?} \text{indicates text missing or illegible when filed}$$

with the singular values σ₁, σ₂, σ₃

The singular values σᵢ are linked to the eigenvalues λᵢ by σᵢ²=(n−1)λᵢ.

The 3×3 matrix V of the singular value decomposition of M contains the eigenvectors υ^{k} of Σ as columns, as shown below starting from Σ with M=UZV^{T}:

$$\sum = \frac{1}{n - 1} {M}^{T} M = \frac{1}{n - 1} V {Z}^{T} {U}^{T} U Z {V}^{T} = \frac{1}{n - 1} V {Z}^{T} Z {V}^{T} ,$$

$$since {U}^{T} U = I$$

$$When Λ = \frac{1}{n - 1} {Z}^{T} Z or$$

$$\text{?} Λ = \frac{1}{n - 1} \begin{matrix}{σ}_{1}^{2} & 0 & 0 \\ 0 & {σ}_{2}^{2} & 0 \\ 0 & 0 & {σ}_{3}^{2}\end{matrix}$$

$$it follows that : \sum = V Λ {V}_{T}$$

$$\text{?} \text{indicates text missing or illegible when filed}$$

This equation can now be multiplied by the matrix V from the right, from which it follows, using V^{T}V=I, that:

$$\sum V = V Λ$$

This last result is equivalent to the eigenvalue equation Συⁱ=λᵢυⁱ, from which it follows that the columns of V represent the eigenvectors of Σ. If the eigenvectors in the columns of V are then also organized by the magnitude of the eigenvalues according to λ₁>λ₂>λ₃, then the matrix V corresponds to the sought rotation matrix Q for rotating the point data cloud from the sensor coordinate system into the computer coordinate system.

The eigenvectors of the covariance matrix Σ for the three largest eigenvalues in this instance are identical to the singular vectors of the difference matrix M.

The calculation of the singular value decomposition of the difference matrix M∈ [symbol] ^{n×3}, n>3, is usually carried out in two steps:

First of all, in a first step, the difference matrix M is transformed into a bidiagonal matrix B using a so-called householder transformation:

$${U}_{B}^{T} M {V}_{B} = B ,$$

where B is a bidiagonal matrix and U_{B}, V_{B}, as the result of the householder transformations, are orthogonal matrices.

In a second step, the superdiagonal elements, i.e., all the elements directly above and to the right of the main diagonal, are then set to zero in an iterative process with an algorithm according to Golub and Kahn:

$${U}_{Z}^{T} B {V}_{Z} = Z = diag ( {σ}_{1} , {σ}_{2} , {σ}_{3} ) ,$$

the matrices U_{Z} and V_{Z} being orthogonal in this instance.

Z then also provides the singular values σ₁, σ₂, σ₃.

V is then subsequently calculated with:

$$V = {V}_{B} {V}_{Z .}$$

The numerical effort for calculating the matrices Z and V in this instance can be estimated to be 2*n*3²+11*3³ arithmetic steps, which thus scale only linearly with the number n of measurement points in the point cloud. This means that 10⁷ measurement points can easily be processed in less than one second on a recent industrial PC and the rotation matrix Q required for registration can be determined. In addition, to obtain a further time reduction, it is possible to run the algorithm in parallel on multiple processors simultaneously, for example on one or more graphics cards. However, in particular in cloud computing, computing operations can also be distributed over multiple processors.

Besides the singular value decomposition of the difference matrix M outlined above, there are numerous other numerical methods that can be used to iteratively determine the singular vectors of the difference matrix M and/or the eigenvectors of the covariance matrix Σ. Ready-to-use solutions in this regard are provided, for example, by open source libraries such as https://eigen.tuxfamily.org/dox/group_SVD_Module.html or specialized libraries for GPGPU https://github.com/scrose/SVDSolver or for distributed computer systems https://github.com/ecrc/ksvd. In addition, alternative calculation methods according to the so-called Krylov-Schur approach and the so-called truncated SVD are known, see https://doi.org/10.1016/j.laa.2011.07.022 and https://arxiv.org/pdf/2009.00761.

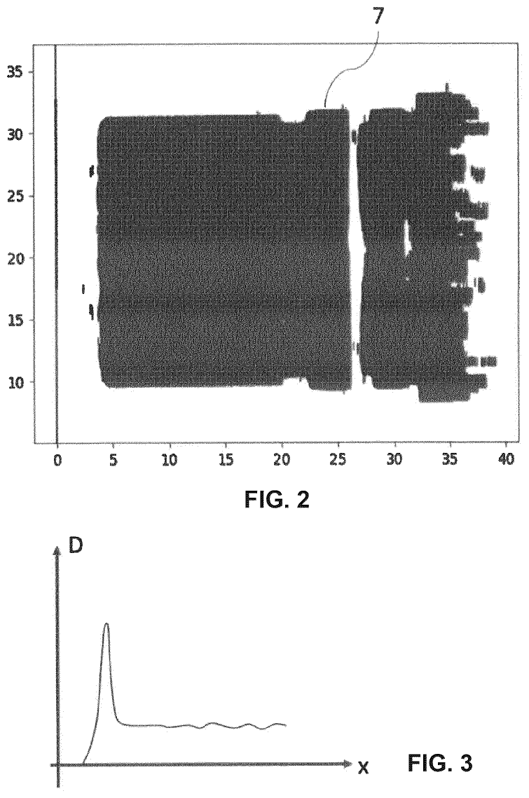

FIG. 2 shows the arrangement of the two-dimensional point cloud shown in FIG. 1 along the determined direction of the main singular vector of the difference matrix or the main eigenvector of the covariance matrix in the horizontal direction as the result of the singular value decomposition (SVD) of the difference matrix formed from the point cloud data of FIG. 1. This arrangement of the two-dimensional point cloud along the main singular vector or main eigenvector or in the X direction corresponds to the rotation of the point cloud from FIG. 1 with the rotation matrix Q into the computer coordinate system. The main singular vector or the main eigenvector in this instance is aligned parallel to the X axis of the computer coordinate system after the rotation with the rotation matrix Q.

Since the two-dimensional point cloud data from FIG. 1 are now oriented along the X direction of the computer coordinate system in the first step of the registration method, see FIG. 2, correct positioning of the point cloud data along the X direction and the Y direction must be carried out according to the second step of the registration method.

There are two options in this regard: first, to place the centroid S or a different arithmetic mean or median of the point cloud at the coordinate origin (centering) or, second, to place an end surface obtained from the point cloud at a specific target coordinate, which can be obtained, for example, from the CAD data or the inspection plans.

The determination of such an end surface of the point cloud data includes calculating the scalar products of the point cloud data from FIG. 1 and the determined singular vectors and/or eigenvectors. Alternatively, the X coordinate of the end surface of the point cloud data of FIG. 2 that have been rotated into the computer coordinate system can also be determined. The scalar products and/or the coordinates are therefore used to determine the most probable initial value and/or final value of the expansion of the workpiece 7 in the direction of a singular vector and/or an eigenvector or in the coordinate direction by considering a density distribution or frequency distribution of the scalar products in the direction of the corresponding singular vector and/or eigenvector or by considering a density distribution or frequency distribution of the coordinates.

In this regard, FIG. 3 schematically shows, in line with the point cloud data of FIG. 2, the density distribution or frequency distribution D of the scalar products <xⁿ|υ¹> of the point cloud data xⁿ and the main singular vector and/or main eigenvector υ¹ normalized to the length l, that is to say the number or density of the scalar products <xⁿ|υ¹>/|υ¹ that yield a specific value x, plotted against this value x. It should be noted in this instance that the general scalar product of a vector and a direction vector normalized to the length 1 is nothing other than the length projection of this vector in the direction of the direction vector.

Since the main singular vector and/or main eigenvector υ¹ of the point cloud data of FIG. 1, after the rotation of the point cloud data in line with FIG. 2, is aligned parallel to the x axis of FIG. 2, this length projection of the point cloud data from FIG. 1 with the scalar product along the direction of the main singular vector and/or main eigenvector υ¹ is equivalent to the length projection of the point cloud data from FIG. 2 with the scalar product along the X direction (1, 0, 0). Or, in other words, the density distribution or frequency distribution D in FIG. 3 merely indicates how often or frequently a specific x value occurs as the X coordinate for the point cloud data of FIG. 2.

It should be noted in this instance that the actual three-dimensional (3D) point cloud data of the transmission shaft 7 in FIGS. 1, 2, and 4 naturally also involve data for the left front surface that are not visible in the two-dimensional depictions of FIGS. 1, 2, and 4 but are present in the underlying 3D data set. The number of these data for the front surface is much larger than the number of data for an outer cylinder having the width Δx. Therefore, the density distribution or frequency distribution D in FIG. 3 for the left front surface has a large peak compared to the rest of the cylinder jacket.

In a corresponding procedure relating to the second main singular vector and/or main eigenvector, which points in the Y direction in FIG. 2 after the rotation of the point data cloud of FIG. 1, a camel or bactrian curve having two humps or peaks is obtained for the density distribution or frequency distribution.

The positions of one peak in the X direction and both peaks in the Y direction can now be determined using all the known methods of peak evaluation. In this regard, the evaluation can be carried out, for example, based on mean values, threshold values, half-value widths, threshold value widths and/or gradients of the local density distributions or frequency distributions.

A simple threshold value method of peak evaluation in one direction can be carried out, for example, by determining an average density D over all the measurement points under consideration in the direction under consideration based on the mean value or median by then considering at which point in the X or Y direction, depending on which direction is currently being considered, the threshold value of D/2 is exceeded.

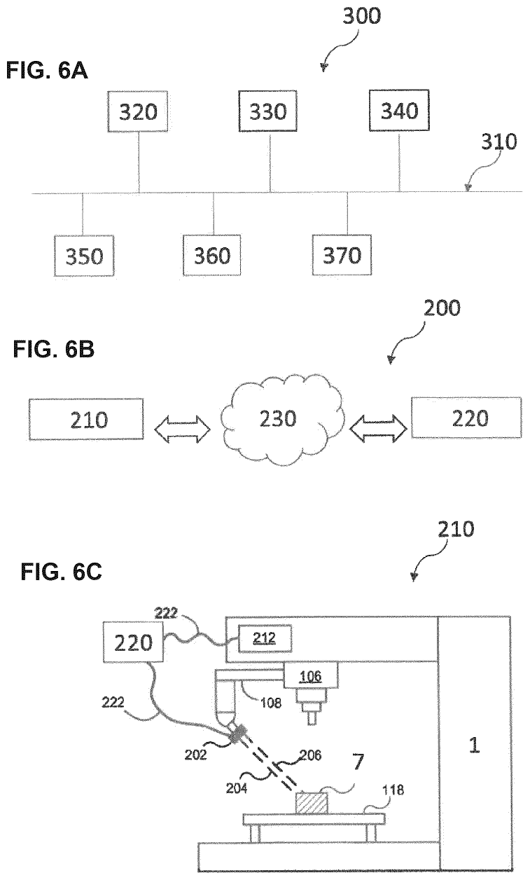

In addition, the end surface of the point cloud data can also be provided by identifying the local maximum and/or the local minimum of the first partial derivative of the density distribution or frequency distribution in the direction of the corresponding singular vector and/or eigenvector. A corresponding method is described in the patent U.S. Pat. No. 8,045,806 B2, in particular with respect to point data clouds from CT measurement images (voxels). The entire disclosure content of the patent U.S. Pat. No. 8,045,806 B2 is hereby incorporated by reference into this application; this applies in particular to FIG. 6 and the associated description of the figures, but in the event of a conflict the present description takes precedence over the description of the patent U.S. Pat. No. 8,045,806 B2. However, the method shown in U.S. Pat. No. 8,045,806 B2 is not just limited to be used for CT data but can be applied to all forms of point data clouds and/or density distributions or frequency distributions of scalar products of point data clouds.

In a further exemplary embodiment of the disclosure, the most probable initial value and/or final value of the expansion of the workpiece (7) in the direction of a singular vector and/or eigenvector and/or in a coordinate direction can be determined by evaluating the density distribution or frequency distribution of the scalar products having the largest and/or smallest absolute value or the coordinates having the largest and/or smallest absolute value in the direction of the corresponding singular vector and/or eigenvector or in the coordinate direction, and, for example, scalar products that diverge by more than 5%, in particular by more than 1%, from the scalar products having the largest and/or smallest absolute value or the coordinates having the largest and/or smallest absolute value are ignored for this evaluation.

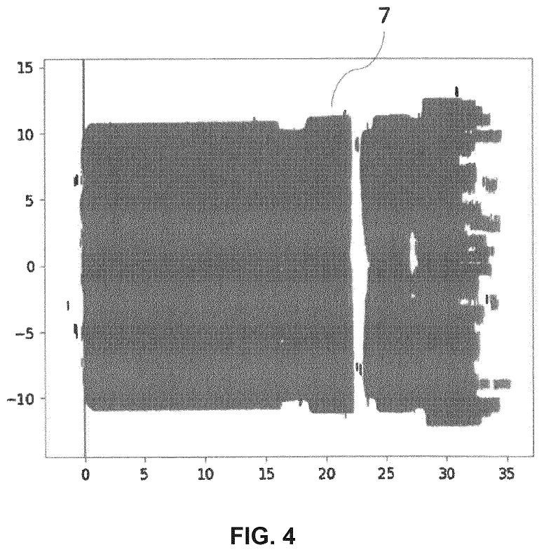

FIG. 4 shows such an arrangement of the two-dimensional point cloud shown in FIG. 1 along the zero line in the horizontal direction and, viewed from the vertical direction, symmetrically with respect to the X axis as a result of the most probable initial values and/or final values of the expansion of the transmission shaft shown in FIG. 1 in the direction of the two main singular vectors or main eigenvectors, or as a result of the most probable initial values and/or final values of the expansion of the transmission shaft shown in FIG. 2 in the X and Y directions, having been determined by considering a density distribution or frequency distribution of the scalar products of point cloud data and singular vectors/eigenvectors in the direction of the two main singular vectors or main eigenvectors or by considering a density distribution or frequency distribution of the coordinates in the X and Y directions. In this regard, the density distribution has one peak in the x direction, in line with FIG. 3, and two peaks in the y direction according to a camel hump or bactrian hump curve.

It should be noted in this instance that the registration method described with reference to FIGS. 1 to 4 has been carried out only with a partial point cloud of measurement data that includes only the head of a transmission shaft 7 and the start of the collar of the transmission shaft 7 with lugs on a ring gear (on the right in the image in FIGS. 1, 2, and 4). This means that the registration method according to an exemplary embodiment of the disclosure can perform the necessary rotation and the necessary displacement of point cloud data into the computer coordinate system reliably and robustly, even if only small partial surfaces of the workpiece under consideration should be present as point cloud data due to, for example, shadowing. In this respect, the present registration method is superior to other registration methods with respect to inline inspection of workpieces in the clock cycle, since it makes use of statistical methods and therefore leaves aside a geometric consideration of the registration problem.

In addition, it should be noted that the term “computer coordinate system” used with respect to the figure description of FIGS. 1 to 4 must not be understood as limiting, but rather is meant to representatively describe any coordinate system in which the point data clouds recorded in the sensor coordinate system are meant to be considered, for example including the CAD coordinate system.

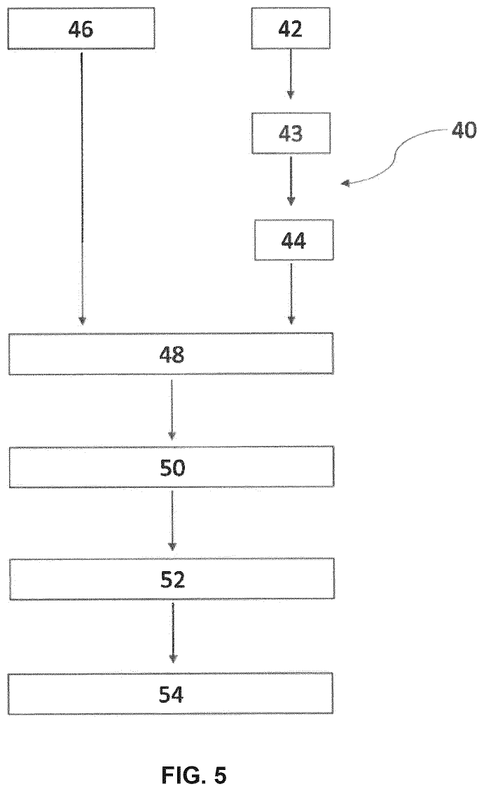

FIG. 5 shows a diagram of the inventive method including the steps of:
obtaining 42 point cloud data of a workpiece 7;
registering 43 the point cloud data of the workpiece 7;
fitting 44 geometric surface elements and/or form elements to the point cloud data of the workpiece 7;
obtaining 46 an inspection plan and/or a CAD model of the workpiece 7 and, where applicable, actual control data and/or, where applicable, available infrastructure or environmental data of at least one manufacturing machine 1 for manufacturing the workpiece 7;
comparing 48 the inspection plan and/or CAD model of the workpiece 7 with the fitted surface elements and/or form elements and identifying divergences;
evaluating or assessing 50 the divergences identified in the comparison, where applicable based on specified tolerances of the workpiece 7 and, where applicable, the actual control data and/or, where applicable, the infrastructure or environmental data;
generating 52 new target control data and/or new infrastructure or environmental data for continued manufacture of the workpiece 7 or for manufacturing a new workpiece 7 in accordance with the evaluation 50;
transferring 54 the new target control data and/or, where applicable, the new infrastructure or environmental data to the at least one manufacturing machine 1 and/or to at least one other manufacturing machine and/or to a factory controller superordinate to the at least one manufacturing machine 1 and/or the at least one other manufacturing machine in accordance with the evaluation 50;
   the registration 43 of the point cloud data of the workpiece 7 being based on a singular value decomposition (SVD) of a difference matrix of the point cloud data with determination of the associated singular vectors and/or on a determination of the eigenvectors of a covariance matrix of the point cloud data that is formed from the difference matrix, the difference matrix being formed from the difference between the point cloud data coordinates and the centroid coordinates of the point cloud.

It should be noted in this instance that all the aforementioned steps 42 to 54 of the method can be carried out completely, for example, in Microsoft's Azure cloud and thus in a manner detached from the control computer of the manufacturing machine 1, each of these steps also being able to be handled in separate software modules in the cloud, and different programs or program parts also being able to be encapsulated and called within the software modules for the respective purpose of the software module.

It is just as conceivable, however, for individual or all steps to be performed locally in situ as individual software modules or as a complete software package on the at least one manufacturing machine 1 and/or on at least one other manufacturing machine and/or on a factory controller superordinate to the at least one manufacturing machine 1 and/or the at least one other manufacturing machine.

Furthermore, it is conceivable for the inventive method to be able to be started and/or controlled from a remote computer, a smartphone app, the control computer of the at least one manufacturing machine 1 and/or the control computer of the at least one other manufacturing machine and/or a control computer of the factory controller superordinate to the at least one manufacturing machine 1 and/or the at least one other manufacturing machine and then for all or individual steps 42 to 54 to be handled for example in the Azure cloud and/or in the remote computer and/or in a smartphone app and/or in the control computer of the at least one manufacturing machine 1 and/or in the control computer of the at least one other manufacturing machine and/or in a control computer of the factory controller superordinate to the at least one manufacturing machine 1 and/or the at least one other manufacturing machine.

In this respect, this method is a computer-implemented method 40, and/or a method that takes place on at least one processor and/or takes place under the control of at least one processor and/or is initiated by at least one processor, for generating control data for at least one manufacturing machine 1, the method 40 including steps 42 to 54 and at least one of steps 42 to 54 of the method 40 being performed on the at least one and/or another processor.

Step 42 “obtaining point cloud data of a workpiece” involves point cloud data of at least one sensor in the sensor coordinate system being obtained that represent coordinates of the part for at least one considered part of the workpiece. These can be surface coordinates that have been recorded, for example, with an optical sensor. However, CT data can also be regarded as corresponding coordinate data of a considered part of the workpiece.

“Obtaining point data clouds” can be understood to mean any form of data transfer, for example including “receiving” point data clouds. However, actively “fetching” such point data clouds or “storing” or “transferring” such point data clouds from or on a computer, a hard disk, any other storage medium and/or in the cloud is also meant to be understood by the feature “obtaining point cloud data”. These illustrative lists for the feature “obtaining” are not intended to be regarded as conclusive, since any form of conceivable data transfer is meant to be covered by the feature “obtaining”.

The point cloud data of step 42 may have been measured by at least one sensor 202 before step 42 as coordinates of points on the workpiece 7 and further-processed by at least one processor to produce point cloud data of the workpiece 7, the point cloud data representing at least one subregion of the workpiece 7 to be manufactured and the point cloud data being further-processed by this and/or at least one other processor according to the other method steps and/or being transferred to other processors for further processing. The sensor 202 may be arranged within or near the at least one manufacturing machine 1, see for example FIG. 6C, and the at least one processor can be a processor of the sensor 202, a processor of the manufacturing machine, a processor of the superordinate factory controller, a processor of the cloud or any other processor that further-processes the sensor signals of the sensor 202 to produce point data clouds.

Step 43 “registering the point cloud data of the workpiece 7” with the feature that the registration 43 of the point cloud data of the workpiece 7 is based on a singular value decomposition (SVD) of a difference matrix of the point cloud data with determination of the associated singular vectors and/or on a determination of the eigenvectors of a covariance matrix of the point cloud data that is formed from the difference matrix, the difference matrix being formed from the difference between the point cloud data coordinates and the centroid coordinates of the point cloud, has already been explained in detail above with reference to FIGS. 1 to 4.

Step 44 “fitting geometric surface elements and/or form elements to the point cloud data of the workpiece 7” involves fitting geometric replacement elements (surface elements and/or form elements) to individual partial point clouds of the point cloud data with an algorithm (usually a Gaussian best-fit algorithm). Various software packages from various manufacturers can be used for this purpose, for example the Caligo® software package or the Calypso® software package from Carl Zeiss Industrielle Messtechnik GmbH and the GOM Inspect® software package from Carl Zeiss GOM GmbH. These software packages can be called by other programs in a manner encapsulated for this purpose and can therefore be used accordingly on front-end computers, on factory control computers or in the cloud. Possible algorithms for “fitting geometric surface elements and/or form elements to the point cloud data of the workpiece 7” are also described in a variety of ways in the relevant literature, see for example “Least Squares Orthogonal Distance Fitting of Curves and Surfaces in Space” by Sung Joon Ahn, Springer-Verlag, ISSN 0302-9743, ISBN 3-540-23966-9.

Step 46 “obtaining an inspection plan and/or a CAD model of the workpiece 7 and, where applicable, actual control data and/or, where applicable, available infrastructure or environmental data of the at least one manufacturing machine 1 for manufacturing the workpiece 7” involves transferring the data intended to be regarded as relevant to production of the workpiece 7. This involves the inspection plan and/or the CAD data of the workpiece 7 to be manufactured and thus the target data of the workpiece 7 to be manufactured, but also, where applicable, the envisaged actual control data for the at least one manufacturing machine 1 for producing the workpiece 7 to be manufactured and/or else, where applicable, the available infrastructure or environmental data of the manufacturing machine 1 for producing the workpiece 7 to be manufactured. “Inspection plan and/or CAD model of workpiece 7” is understood in this instance to mean all possible geometric target data of the workpiece that are suitable for comparison with the acquired actual data. In this respect, these can also be data derived from the inspection plan and/or CAD model and/or from any design drawings.

“Obtaining” can be understood to mean any form of data transfer, for example including “receiving” data. However, actively “fetching” such data or “storing” or “transferring” such data from or on a computer, a hard disk, any other storage medium and/or in the cloud is also meant to be understood by the feature “obtaining”. These illustrative lists for the feature “obtaining” are not intended to be regarded as conclusive, since any form of conceivable data transfer is meant to be covered by the feature “obtaining”.

An inspection plan can be created based on CAD data of a CAD model or based on other manufacturing data by various software packages from various manufacturers, for example, the Caligo® software package or the Calypso® software package from Carl Zeiss Industrielle Messtechnik GmbH and the GOM Inspect® software package from Carl Zeiss GOM GmbH. These software packages can be called by other programs in a manner encapsulated for this purpose and can therefore also be used accordingly on front-end computers, on factory control computers or in the cloud, additionally or independently of step 44, for inspection plan creation and/or for the transmission of CAD data of a CAD model in step 46.

Accordingly, the inspection plan and/or the CAD model of the workpiece 7 and, where applicable, the actual control data and/or, where applicable, the available infrastructure or environmental data of the at least one manufacturing machine 1 can be preprocessed and transferred by at least one processor of the at least one manufacturing machine 1 and/or by at least one processor of the factory controller superordinate to the manufacturing machine 1.

It should also be noted in this instance that step 46 can be carried out before, at the same time as or after steps 42, 43, and 44 and thus independently of steps 42, 43 and 44; see also the illustration in FIG. 5.

Step 48 “comparing the inspection plan and/or CAD model of the workpiece 7 with the fitted surface elements and/or form elements and identifying divergences” first involves a pure target/actual comparison being performed for the workpiece, taking into account the inspection plan or CAD model and, where applicable, associated tolerances. Again, various software packages from various manufacturers can be used for this purpose, for example the Caligo® software package or the Calypso® software package from Carl Zeiss Industrielle Messtechnik GmbH and the GOM Inspect® software package from Carl Zeiss GOM GmbH. These software packages can be called by other programs in a manner encapsulated for this purpose and can therefore also be used accordingly on front-end computers, on factory control computers or in the cloud, additionally or independently of step 44 and additionally or independently of step 46, for target/actual comparison of the workpiece according to step 48.

Step 50 “evaluating or assessing 50 the divergences identified in the comparison, for example based on, where applicable, specified tolerances of the workpiece 7 and, where applicable, the actual control data and/or, where applicable, the infrastructure or environmental data” first involves an assessment being carried out as to whether the identified divergences of the workpiece 7 are acceptable, for example based on, where applicable, specified tolerances, or whether the identified divergences are no longer acceptable. In the latter case, a check is then performed to ascertain whether the identified divergences are reworkable or retolerable, for example in terms of a combination of sets, or whether the workpiece 7 should be assessed as a reject. If a divergence is reworkable, the requisite new target control data for the at least one manufacturing machine 1 and/or the at least one other manufacturing machine are defined. Furthermore, if ACTUAL control data are available and/or, where applicable, infrastructure or environmental data of the manufacturing machine 1 are available, a check is performed to ascertain whether the identified divergences from the ACTUAL control data and/or infrastructure or environmental data have a certain correlation, so that new TARGET control data and/or new infrastructure data for manufacturing new workpieces 7 can be derived based on this correlation.

For example, a very simple feedback model for step 50 merely uses the divergences identified on the workpiece as a negative offset from the original actual control data and generates new target control data therefrom. That is to say that if, for example, the original actual control data contained a workpiece length of 100 mm for the workpiece 7 and the workpiece 7 is then 50 μm too long (identified divergence), then the new target data are simply accorded provision for a workpiece length of 100 mm-50 μm. However, a simple feedback model for step 50 such as this only works as long as a reasonably linear relationship between control data and resulting dimensions of the workpiece 7 can be assumed.

In this regard, a typical error for turning applications is wear on tools, for example. The resulting error often manifests itself as divergences in diameters. This error is usually corrected by computer numerical control (CNC) operators with a manual input into an offset table that a CNC manufacturing machine uses to determine the correct attitude of the tool center point. In practical terms, the delivery of the tool is thus adapted, affecting the diameter produced and permitting a correction. Often, the measured error is multiplied by a factor to correct the offset table. In practice, these factors come from the specialist knowledge of the CNC operators and are determined empirically. The need for factors in this instance is due to the physical deformations of the component at the time of machining. This includes, for example, thermal and also force-related processes.

Use of the method according to an exemplary embodiment of the disclosure now allows fine adjustment of the factors in the offset table with the simple feedback model for step 50, since the influence due to the measurement of the workpiece 7 can be directly observed. Once the factors and compensations found with the offset table are determined, production control can take place almost autonomously and without manual intervention by the CNC operator.

There are also reasons other than tool wear that necessitate a correction. For example, the axis of rotation moves during the warm-up phase of a CNC manufacturing machine. This error can also be compensated for by appropriately adjusting the offset table. Thus, the method of adapting the offset table with the simple feedback model of step 50 can be applied to many error patterns. This type of compensation is moreover not limited to turning machines, since milling machines, for example, are also affected by an incorrect attitude of the tool center point. A simple feedback model for step 50 of the inventive method for improving workpiece quality can also be usefully used for other production processes, such as laser deposition welding or 3D printing.

In addition, machine learning algorithms or trained AI systems can also be used to derive or define new target control data from identified divergences. In particular, so-called reinforced learning algorithms can be used beneficially for complex causal relationships in order to provide an effective feedback model for step 50. In this regard, U.S. Pat. No. 10,180,667 B2, for example, describes a measurement technology integrated in a manufacturing machine, in which the measurement results are interpreted by a trained AI, the AI then deriving or defining new target control data.

Other feedback models based on a model-like simulation of the physical processes in the manufacturing machine or based on a black box approach for the manufacturing machine are also conceivable as a feedback model for step 50 of the inventive method. Therefore, the present disclosure is not limited to a specific feedback model for step 50, but rather it is possible to use all possible feedback models for step 50 which are able to derive or define meaningful new target control data.

Step 52 “generating new target control data and/or new infrastructure or environmental data for continued manufacture of the workpiece 7 or for manufacturing a new workpiece 7 in accordance with the evaluation 50” involves the new target control data and/or new infrastructure or environmental data defined or derived in step 50 being compiled for continued manufacture of the workpiece 7 or for manufacturing a new workpiece 7 or provided for transfer to the at least one manufacturing machine 1 and/or to the at least one other manufacturing machine and/or to the factory controller superordinate to the at least one manufacturing machine 1 and/or the at least one other manufacturing machine.

Step 54 “transferring the new target control data and/or, where applicable, the new infrastructure or environmental data to the at least one manufacturing machine 1 and/or to at least one other manufacturing machine and/or to a factory controller superordinate to the at least one manufacturing machine 1 and/or the at least one other manufacturing machine in accordance with the evaluation 50” involves the new target control data and/or, where applicable, the new infrastructure or environmental data being transferred accordingly.

“Transferring” can be understood to mean any form of data transfer, for example including “sending” data. However, actively “storing” such data or “transferring” such data from or on a computer, a hard disk, any other storage medium and/or in the cloud is also meant to be understood by the feature “transferring”. These illustrative lists for the feature “transferring” are not intended to be regarded as conclusive, since any form of conceivable data transfer is meant to be covered by the feature “transferring”.

Subsequently, the new target control data and/or, where applicable, the new infrastructure or environmental data can be further processed by at least one processor of the at least one manufacturing machine 1 and/or the at least one other manufacturing machine and/or by at least one processor of the factory controller superordinate to the at least one manufacturing machine 1 and/or the at least one other manufacturing machine, for manufacturing the new workpiece 7.

However, it goes without saying that a positive evaluation in step 50 requires no new target control data and/or no new infrastructure or environmental data to be generated and subsequently transferred for continued manufacture of the workpiece 7 or for manufacturing a new workpiece 7, since the workpiece 7 currently measured for the evaluation meets the required specification, of course.

In a further exemplary embodiment of the disclosure, step 46 can involve actual control data and/or infrastructure or environmental data being obtained continuously during manufacture of the new workpiece 7 or only at specific times during manufacture of the workpiece 7. In particular, the actual control data and/or, where applicable, the available infrastructure or environmental data of the at least one manufacturing machine 1 for manufacturing the workpiece 7 can be acquired from or in the environment of the at least one manufacturing machine 1 continuously or only at specific times during manufacture of the workpiece 7.

In this instance, machine data of the at least one manufacturing machine 1, for example the tool type, the tool number and the service life of a tool used in the machining head of the at least one manufacturing machine 1, the present feed rate of the machining head, any accelerations of the machining head, the present power requirements of the machining head, the currently used amount of coolant, the laser parameters of a laser machining head, the deposition parameters of a 3D printhead, the temperature and/or humidity of the machining environment inside and/or outside of the at least one manufacturing machine 1, etc., can be acquired or obtained as actual control data and/or infrastructure or environmental data. These actual data continuously or sporadically acquired or obtained during manufacture of the workpiece 7 are thus a chronologically ordered record of a plurality of process parameters for manufacturing the workpiece 7, a corresponding process parameter sequence in this instance being acquired or obtained for each process parameter in step 46.

In the further exemplary embodiment of the disclosure, in an assignment step 46a, which is not shown in larger detail in FIG. 5, this plurality of process parameter sequences of the process parameters used for manufacturing the workpiece 7 can then be assigned (mapping data) to the production steps originally intended for production. In this instance, each actual control command within the original actual control data for the at least one manufacturing machine 1 is assigned process parameters at a time or in a period of time when the actual control command is executed on the at least one manufacturing machine 1.

In this other exemplary embodiment of the disclosure, step 50 “evaluating or assessing 50 the divergences identified in the comparison based on, where applicable, specified tolerances of the workpiece 7 and, where applicable, the actual control data and/or, where applicable, the infrastructure or environmental data” can then involve an assessment being carried out in which, besides the above-described consideration of the identified divergences, the mapping data of step 46a described above are additionally and/or alternatively also included or taken into account.

In this exemplary embodiment of the disclosure, the computer-implemented method 40, and/or the method that takes place on at least one processor and/or takes place under the control of at least one processor and/or is initiated by at least one processor, for generating control data for at least one manufacturing machine 1 includes the following steps, at least one of the following steps of the method 40 being performed on the at least one and/or another processor:
obtaining 42 point cloud data of a workpiece 7;
registering 43 the point cloud data of the workpiece 7;
fitting 44 geometric surface elements and/or form elements to the point cloud data of the workpiece 7;
obtaining 46 an inspection plan and/or a CAD model of the workpiece 7 and actual control data and/or, where applicable, available infrastructure or environmental data of at least one manufacturing machine 1 for manufacturing the workpiece 7, the actual control data and/or the, where applicable, available infrastructure or environmental data being process parameters that are obtained as part of step 46 continuously or only at specific times during manufacture of the workpiece 7;
assigning 46a (mapping) a plurality of process parameter sequences of the process parameters obtained in step 46 to the individual production steps required for manufacturing the workpiece 7 to generate corresponding mapping data, by assigning each actual control command within the original actual control data for the at least one manufacturing machine 1 process parameters at a time or during a period of time when the actual control command is executed;
comparing 48 the inspection plan and/or CAD model of the workpiece 7 with the fitted surface elements and/or form elements and identifying divergences;
evaluating or assessing 50 the divergences identified in the comparison, where applicable based on specified tolerances of the workpiece 7 and the actual control data and/or, where applicable, the infrastructure or environmental data, the mapping data of step 46a additionally and/or alternatively being included or taken into account;
generating 52 new target control data and/or new infrastructure or environmental data for continued manufacture of the workpiece 7 or for manufacturing a new workpiece 7 in accordance with the evaluation 50; and
transferring the new TARGET control data and/or, where applicable, the new infrastructure or environmental data to the at least one manufacturing machine 1 and/or to at least one other manufacturing machine and/or to a factory controller superordinate to the at least one manufacturing machine 1 and/or the at least one other manufacturing machine in accordance with the evaluation 50;
   the registration 43 of the point cloud data of the workpiece 7 being based on a singular value decomposition (SVD) of a difference matrix of the point cloud data with determination of the associated singular vectors and/or on a determination of the eigenvectors of a covariance matrix of the point cloud data that is formed from the difference matrix, the difference matrix being formed from the difference between the point cloud data coordinates and the centroid coordinates of the point cloud.

It goes without saying that, in the present disclosure and in the further exemplary embodiment of the disclosure described above, step 52 for generating new target control data and/or new infrastructure or environmental data for continued manufacture of the workpiece 7 or for manufacturing a new workpiece 7 does not explicitly have to be carried out in accordance with the evaluation 50 but rather can also be a direct result of assessment step 50, which implicitly results from the evaluation of the divergences identified in the comparison, where applicable based on specified tolerances of the workpiece 7 and, where applicable, the actual control data and/or, where applicable, the infrastructure or environmental data, the mapping data of step 46a additionally and/or alternatively also being able to be included or taken into account. In this respect, steps 50 and 52 do not have to be performed separately and in isolation from one another in the present disclosure, but rather can also be performed within a single step together, simultaneously or sequentially, in interwoven fashion or in combination, without thereby departing from the scope of the present disclosure.

Furthermore, it goes without saying that the generation 52 of new target control data and/or new infrastructure or environmental data for manufacturing a new workpiece 7 in accordance with the evaluation 50 and the transfer of the new target control data and/or the, where applicable, new infrastructure or environmental data to the at least one manufacturing machine 1 and/or to at least one other manufacturing machine and/or to a factory controller superordinate to the manufacturing machine 1 and/or the at least one other manufacturing machine in accordance with the evaluation 50 also encompasses another, separate manufacturing machine that does not necessarily have to correspond to the design of the manufacturing machine 1 and that produces a new workpiece 7 with the new target control data in the same factory or at another site in a different country. In this instance, the factory controller can also operate across sites or across countries with respect to the manufacturing machines.

Furthermore, it will be understood that the at least one manufacturing machine 1 and the at least one other manufacturing machine are interchangeable concepts, meaning that the workpiece 7 to be manufactured can also be produced on the at least one other manufacturing machine, in which case applicable actual data of the workpiece 7 can also be acquired on this other manufacturing machine, for example with optical sensors, and in which case, based on the disclosure, new target control data for manufacturing a new workpiece 7 can also be generated for the manufacturing machine 1.

Furthermore, the further exemplary embodiment of the disclosure described above permits the plurality of process parameter sequences to be logged during the production steps to create a historical log book about the production of one or more workpieces 7. This type of log book permits time-resolved error analysis or production monitoring. In this respect, the manufacturing machine is thus no longer a black box that delivers a finished workpiece 7 that can then be qualified after production, resulting in empirical or historical production rules for producing the workpiece 7 being derived.

Therefore, the further exemplary embodiment of the disclosure can be used to avoid very high requirements for the necessary manufacturing accuracy of the manufacturing machinery out of ignorance or fear, and also dependence on the individual knowledge of the operators of manufacturing machines. The log book can also establish an indirect or virtual in-situ measurement technology for the workpiece 7, as it is possible to assign process parameter sequences and control data to geometric target data of the workpiece 7.

The assignment (mapping), which involves each actual control command within the original actual control data for the at least one manufacturing machine 1 being assigned process parameters at a time or during a period of time when the ACTUAL control command is executed, allows the complex cause-effect relationship between the production process, in which many different causes can accumulate to produce a dimensional error for the workpiece 7, and the production result to be selectively examined.

The more information is available, whether through appropriately dense recording or monitoring of the process parameters during manufacture of a workpiece 7 or through the use of an appropriate amount of information from previous production processes, the better the cause-effect relationship can be coached or modelled by an algorithm, for example a machine learning algorithm with reinforced learning, for example.

In this respect, this allows new target control data to be generated that can be used for continued manufacture of the workpiece 7 or to produce new workpieces 7 with fewer errors or divergences. Thus, the disclosure can be used for time-resolved advance error correction during the production process by monitoring and evaluating the current process parameters in a time-resolved manner and by providing time-resolved generation of new target control data as an improved feedback method for the industrial production of workpieces 7.

FIG. 6B shows a diagram of an example environment 200 in which the inventive systems and/or methods may be implemented. As shown in FIG. 6B, the environment 200 can include a manufacturing system 210 having at least one manufacturing machine 1, a control device 220 having at least one processor and a network 230. Devices in the environment 200 can be connected to one another using wired connections, wireless connections or a combination of wired and wireless connections.

The control device 220 includes one or more devices capable of receiving, storing, generating, processing and/or providing information concerning the control or configuration of the manufacturing system 210. For example, the control device 220 can include a server, a computer, a portable device, a cloud computer device and/or the like. In some implementations, the control device 220 can receive information from one or more other devices in the environment 200, such as the manufacturing system 210, and/or provide information.

The network 230 includes one or more wired and/or wireless networks. For example, the network 230 can include a mobile radio network (e.g., a Long-Term Evolution (LTE) network, a Code Division Multiple Access (CDMA) network, a 3G network, a 4G network, a 5G network, another type of next-generation network, etc.), a public mobile land network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic network, a cloud computing network or the like and/or a combination of these or other types of networks.

The arrangement of devices and networks shown in FIG. 6A serves as an example. In practice, there may be additional devices and/or networks, fewer devices and/or networks, other devices and/or networks, or devices and/or networks arranged differently than those shown in FIG. 6A. Furthermore, two or more of the devices shown in FIG. 6A may be implemented within a single device, or a single device shown in FIG. 6A may be implemented as multiple distributed devices. Additionally or alternatively, a number of devices (e.g., one or more devices) in the environment 200 can perform one or more functions described as being performed by another set of devices in the environment 200.

FIG. 6A shows a diagram of example components of a device 300. The device 300 may correspond to the manufacturing system 210 and/or the control device 220. In some implementations, the manufacturing system 210 and/or the control device 220 can include one or more devices 300 and/or one or more components of the device 300. As shown in FIG. 6A, the device 300 can include a bus 310, a processor 320, a memory 330, a memory component 340, an input component 350, an output component 360 and a communication interface 370.

The bus 310 contains a component that permits communication between the components of the device 300.

The processor 320 is implemented in hardware, firmware or a combination of hardware and software. The processor 320 is a central processing unit (CPU), a graphics processing unit or a graphics processor (GPU), an accelerated processing unit (APU), a microprocessor, a microcontroller, a digital signal processor (DSP), a Field-Programmable Gate Array (FPGA), an application-specific integrated circuit (ASIC), or another type of processing component. In some implementations, the processor 320 includes one or more processors that can be programmed to perform a function.

The memory 330 includes one or more memories, such as a main memory (RAM), a read-only memory (ROM) and/or another type of dynamic or static memory device (e.g., a flash memory, a magnetic memory and/or an optical memory), which stores information and/or instructions for use by the processor 320.

The memory component 340 stores information and/or software concerning the operation and use of the device 300. For example, the memory component 340 can include a hard disk (e.g., a magnetic disk, an optical disk, a magneto-optical disk and/or a solid-state disk), a compact disc (CD), a digital versatile disc (DVD), a floppy disk, a cassette, a magnetic tape and/or other type of nonvolatile computer-readable media along with an appropriate drive.

The input component 350 includes a component that permits the device 300 to receive information, for example via user inputs (e.g., a touchscreen display, a keyboard, a keypad, a mouse, a button, a switch and/or a microphone). Additionally or alternatively, the input component 350 can also include at least one sensor for acquiring information. These can be, for example, triangulation sensors or stripe projection sensors for acquiring surface coordinates of a workpiece 7 or else sensors for acquiring the infrastructure or environmental data of the manufacturing machine 1.

The output component 360 includes a component that provides output information from the device 300 (for example a display, a loudspeaker and/or one or more light-emitting diodes (LEDs)).

The communication interface 370 includes a transceiver-like component (e.g., a transceiver and/or a separate receiver and transmitter) that permits the device 300 to communicate with other devices, for example via a wired connection, a wireless connection or a combination of wired and wireless connections. The communication interface 370 can permit the device 300 to receive information from another device and/or to forward information to another device. For example, the communication interface 370 can include an Ethernet interface, an optical interface, a coaxial interface, an infrared interface, a radio-frequency (RF) interface, a Universal Serial Bus (USB) interface, a WiFi interface, a mobile radio network interface or the like.

The device 300 can perform one or more of the above-described method steps 42 to 54 and also the entire method according to an exemplary embodiment of the disclosure. The device 300 can perform these method steps or the method based on the processor 320, which executes software instructions that are stored by a non-transitory computer-readable medium, such as the memory 330 and/or the memory component 340. A computer-readable medium is defined herein as a non-transitory storage apparatus. A storage device includes storage space within a single physical storage device or storage space distributed across multiple storage devices.

Software instructions can be read to the memory 330 and/or the memory component 340 from another computer-readable medium or from another device via the communication interface 370. When software instructions stored in the memory 330 and/or in the memory component 340 are executed, this can cause the processor 320 to perform one or more of the above-described method steps 42 to 54. Additionally or alternatively, hard-wired circuits can be used instead of or in combination with software instructions to perform one or more of the described method steps. Therefore, the implementations described herein are not limited to a specific combination of hardware circuits and software.

FIG. 6C shows an example of a manufacturing system 210 that includes at least one manufacturing machine 1 and at least one control device 220 and also, where applicable, a factory controller for controlling the at least one manufacturing machine 1 and/or for controlling at least one other manufacturing machine. The control device 220 in this instance may be connected locally via data lines 222, via a network 230 and/or via a bus 310 to the controller 212 of the manufacturing machine 1 and/or to the sensor 202 of the manufacturing system 210 for data transfer purposes.

In FIG. 6C, a workpiece 7 that has already been machined or is still to be machined is mounted on the workpiece table 118 of the manufacturing machine 1. The production head 106 of the manufacturing machine 1 is used for subtractive, that is to say cutting, or additive machining of the workpiece 7. A moving arm and/or robot 108 is used to move the sensor 202 relative to the workpiece 7. Additionally or alternatively, a moving arm and/or robot 108 can also be used to move the workpiece relative to the sensor 202. In the exemplary embodiment shown in FIG. 6C, the sensor 202 has an optical exposure beam 206 and a measuring beam 204 reflected from the workpiece. Therefore, this may be a triangulation or stripe projection sensor 202. However, the present disclosure is not limited to a specific sensor type, and so all sensor types that can generate a point cloud can be used.

The present disclosure is also not limited to only measuring and evaluating a finished workpiece 7. For example, the present disclosure can be used to evaluate partial machining steps and/or the machining progress in situ, since the registration method can process incomplete partial point clouds of the workpiece in a very short time. For such evaluation of the workpiece 7 alongside production, either there is the possibility of the sensor 202 and the workpiece 7 being moved relative to one another by at least one corresponding actuator 108 during machining or during a break in machining or there may be sufficient sensors 202 to cover the areas of interest of the entire workpiece 7.

It will be understood that the exemplary embodiments shown in the figures and described in the description are merely used to schematically illustrate the principle and execution of the present disclosure. Various permutations of a functional and structural nature are possible without departing from the scope of the present disclosure.

What is claimed is:

1. A computer-implemented method, and/or a method carried out on at least one processor and/or carried out under a control of the at least one processor and/or initiated by the at least one processor, for generating control data for controlling at least one manufacturing machine, the method comprising the following steps and at least one of the following steps of the method being performed on the at least one processor and/or another processor:
obtaining point cloud data of a workpiece;
registering the point cloud data of the workpiece;
fitting geometric surface elements and/or form elements to the point cloud data of the workpiece;
obtaining at least one of an inspection plan, a computer-aided design (CAD) model of the workpiece, actual control data, and available infrastructure or environmental data of at least one manufacturing machine for manufacturing the workpiece;
comparing the inspection plan and/or CAD model of the workpiece with the fitted geometric surface elements and/or form elements and identifying divergences;
evaluating or assessing the divergences identified in the comparing based on at least one of specified tolerances of the workpiece, the actual control data, and the infrastructure or environmental data;
generating new target control data and/or new infrastructure or environmental data for continued manufacture of the workpiece or for manufacturing a new workpiece in accordance with the evaluating and assessing of the divergences identified in the comparison; and
transferring at least one of the new target control data and the new infrastructure or environmental data to the at least one manufacturing machine and/or to at least one other manufacturing machine and/or to a factory controller superordinate to the manufacturing machine and/or the at least one other manufacturing machine in accordance with the evaluating or assessing of the divergences identified in the comparison,
wherein registering the point cloud data of the workpiece is based on a singular value decomposition (SVD) of a difference matrix of the point cloud data with a determination of associated singular vectors and/or based on a determination of eigenvectors of a covariance matrix of the point cloud data which is formed from the difference matrix, the difference matrix being formed from a difference between point cloud data coordinates and centroid coordinates of the point cloud,
wherein registering the point cloud data of the workpiece further comprises calculating scalar products of the point cloud data and at least two determined singular vectors and/or eigenvectors, and/or
wherein registering the point cloud data of the workpiece further comprises determining at least two coordinates in the X and/or Y and/or Z direction of the point cloud data coordinates rotated into the computer coordinate system or CAD coordinate system.

2. The method as claimed in claim 1, wherein the scalar products and/or the coordinates are used to determine a most probable initial value and/or a final value of the expansion of the workpiece in a direction of a singular vector and/or an eigenvector and/or in a coordinate direction by considering a density distribution or a frequency distribution of the scalar products in the direction of a corresponding singular vector and/or the eigenvector and/or by considering the density distribution or the frequency distribution of the coordinates.

3. The method as claimed in claim 2, wherein, when considering the density distribution or frequency distribution of the scalar products and/or the coordinates, evaluating or assessing of the divergences is performed based on mean values, threshold values, half-value widths, threshold value widths and/or gradients of local density distributions or frequency distributions.

4. The method as claimed in claim 2, wherein the most probable initial value and/or the final value of the expansion of the workpiece is determined by identifying a local maximum and/or a local minimum of a first partial derivative of the density distribution or frequency distribution in the direction of the corresponding singular vector and/or the eigenvector and/or in the coordinate direction, and
wherein, when ambiguities occur, a first extremum in the direction under consideration is used.

5. The method as claimed in claim 2, wherein the most probable initial value and/or the final value of the expansion of the workpiece in the direction of the singular vector and/or the eigenvector and/or in the coordinate direction is determined by evaluating the density distribution or frequency distribution of the scalar products or coordinates having a largest or a smallest absolute value, and
wherein the scalar products or the coordinates that diverge by more than 5% from the scalar products or the coordinates having the largest or the smallest absolute value are ignored when evaluating or assessing the divergences.

6. The method as claimed in claim 1, wherein registering the point cloud data of the workpiece is carried out based on a parallelization by or with an involvement of at least one graphics processor.

7. The method as claimed in claim 1, wherein the point cloud data of the workpiece are measured by at least one sensor as coordinates of points on the workpiece and are further-processed by the at least one processor to generate further point cloud data of the workpiece, the further point cloud data representing at least one subregion of the workpiece to be manufactured and the point cloud data being further-processed by the at least one processor and/or by at least one other processor in accordance with other method steps and/or being transferred to other processors for further processing.

8. The method as claimed in claim 1, wherein the at least one of the inspection plan, the CAD model of the workpiece, the actual control data, and the available infrastructure or environmental data of the at least one manufacturing machine are preprocessed and transferred by the at least one processor of the at least one manufacturing machine and/or by at least one processor of the factory controller superordinate to the at least one manufacturing machine.

9. The method as claimed in claim 1, wherein the new target control data and/or the new infrastructure or environmental data are further processed by the at least one processor of the at least one manufacturing machine and/or the at least one other manufacturing machine and/or by the at least one processor of the factory controller superordinate to the at least one manufacturing machine and/or the at least one other manufacturing machine, for manufacturing the new workpiece.

10. A computer program comprising commands that, when the computer program is executed by the at least one processor, causes the at least one processor and/or other processors to carry out the method as claimed in claim 1.

11. A data carrier signal that transmits all or part of the computer program as claimed in claim 10.

12. A manufacturing system, comprising:
a computer program as claimed in claim 11; and
the at least one processor.

13. A manufacturing system, comprising:
at least one processor and at least one memory, the at least one processor interchanging data with the at least one memory, and
the manufacturing system being configured to:
obtain point cloud data of a workpiece;
register the point cloud data of the workpiece;
fit geometric surface elements and/or form elements to the point cloud data of the workpiece;
obtain at least one of an inspection plan, a CAD model of the workpiece, actual control data, and available infrastructure or environmental data of at least one manufacturing machine for manufacturing the workpiece;
compare the inspection plan and/or CAD model of the workpiece with the fitted surface elements and/or form elements and identifying divergences;
evaluate or assess the divergences identified in the comparison based on at least one of specified tolerances of the workpiece, the actual control data, and the infrastructure or environmental data;
generate new target control data and/or new infrastructure or environmental data for continued manufacture of the workpiece or for manufacturing a new workpiece in accordance with the evaluating or assessing of the divergences identified in the comparison;
transfer at least one of the new target control data and the new infrastructure or environmental data to the at least one manufacturing machine and/or to at least one other manufacturing machine and/or to a factory controller superordinate to the at least one manufacturing machine and/or the at least one other manufacturing machine in accordance with an evaluation or assessment of the divergences identified in when the inspection plan and/or CAD model of the workpiece are compared with the fitted surface elements and/or form elements;
wherein when the point cloud data of the workpiece is registered based on a singular value decomposition (SVD) of a difference matrix of the point cloud data with a determination of associated singular vectors and/or based on a determination of eigenvectors of a covariance matrix of the point cloud data that is formed from the difference matrix, the difference matrix is formed from a difference between point cloud data coordinates and the centroid coordinates of the point cloud, and
wherein when the point cloud data of the workpiece is registered the scalar products of the point cloud data and at least two determined singular vectors and/or eigenvectors are calculated, and/or
wherein when the point of cloud data of the workpiece is registered, at least two coordinates in the X and/or Y and/or Z direction of the coordinates of the point cloud data rotated into the computer coordinate system or CAD coordinate system are determined.

14. The method as claimed in claim 2, wherein the most probable initial value and/or the final value of the expansion of the workpiece in the direction of the singular vector and/or the eigenvector and/or in the coordinate direction is determined by evaluating the density distribution or the frequency distribution of the scalar products or coordinates having a largest or a smallest absolute value, and
wherein the scalar products or the coordinates that diverge by more than 1% from the scalar products or the coordinates having the largest or the smallest absolute value are ignored when evaluating or assessing the divergences.
